(19) United States
(12) Patent Application Publication
(10) Pub. No.: US 2026/0145641 A1
(43) Pub. Date: May 28, 2026

(54) Method and Device for Restoring Access to a Motor Vehicle Using a Digital Access Key

(71) Applicant: Bayerische Motoren Werke Aktiengesellschaft, Muenchen (DE)

(72) Inventor: Tomas URBAN, Holzkirchen (DE)

(21) Appl. No.: 19/382,382

(22) Filed: Nov. 7, 2025

(30) Foreign Application Priority Data
Nov. 22, 2024 (DE) 10 2024 134 527.6

(51) Int. Cl. B60R 25/24; B60R 25/25; B60R 25/30; G07C 9/00; G07C 9/25

(52) U.S. Cl. CPC B60R 25/24; B60R 25/25; B60R 25/305; G07C 9/00309; G07C 9/00563; G07C 9/25; B60R 2325/205; G07C 2009/00793; G07C 2209/08

(57) ABSTRACT

A method and a device for restoring access to a motor vehicle using a digital access key are provided. The method includes detecting a generation request to generate a replacement digital access key for the motor vehicle by a user on a user terminal, wherein the user previously had access to a valid digital access key for the motor vehicle, verifying the user using the user terminal, and creating a replacement digital access key for the motor vehicle on the user terminal in response to the verification of the user.

### CROSS REFERENCE TO RELATED APPLICATION

This application claims priority under 35 U.S.C. § 119 from German Patent Application No. DE 10 2024 134 527.6, filed Nov. 22, 2024, the entire disclosure of which is herein expressly incorporated by reference.

### BACKGROUND AND SUMMARY

The invention relates to a method and to a device for restoring access to a motor vehicle using a digital access key.

There are solutions that enable access and, in particular, unlocking of a motor vehicle using a so-called smart device. This is usually done after a digital access key has been configured on the smart device.

Document DE 10 2015 223 342 A1, for example, specifies a method for operating an authorization device for a vehicle, which authorization device is designed for initial communication with the vehicle and has a locating unit designed to determine a current location of the authorization device.

The object of the invention is to provide an improved method and an improved device for restoring access to a motor vehicle using a digital access key.

This object is achieved in accordance with the invention by the subjects of the independent patent claims. The dependent patent claims and the description relate to advantageous embodiments of the invention.

A method according to the invention for restoring access to a motor vehicle using a digital access key comprises the steps of detecting a generation request to generate a replacement digital access key for the motor vehicle by a user on a user terminal, wherein the user previously had access to a valid digital access key for the motor vehicle, verifying the user using the user terminal, and creating a replacement digital access key for the motor vehicle on the user terminal in response to the verification of the user.

The method according to the invention is used, in particular, to generate a replacement digital access key for a user after an originally valid digital access key can no longer be used, for example, because a user terminal comprising the originally valid digital access key has a fault or has gone missing and is therefore no longer usable for the use of the original digital access key to access the vehicle.

The user terminal in this case is a unit or a device designed to receive operator control inputs, user inputs and/or user commands and to communicate with a motor vehicle to provide these operator control inputs to the motor vehicle and thereby trigger functions in the motor vehicle.

In particular, the user terminal is a portable or mobile device which is different from the motor vehicle and which can be designed, in particular, as a so-called smart device, that is to say as a device having at least one processor apparatus, for example, a smartphone, a phablet or a tablet, a smart watch, smart glasses and/or a wearable, which also provides other functions, such as making calls, surfing the Internet or providing messaging services, for example, through applications or programs.

In particular, the user terminal is designed to trigger or perform one or more functions in relation to one or more motor vehicles, such as locking and/or unlocking one or more flaps, such as doors, and also the active opening and/or closing of one or more of such flaps, as well as the release of an immobilizer, the starting of an engine and/or the forward travel of the motor vehicle.

Such functions or interactions with the motor vehicle, including those enabling access to the motor vehicle and, in particular, flap control and/or movement of the motor vehicle, can also be referred to as secure and/or protected functions and are supported in or implemented by the user terminal, in particular by a secure module. Such a secure module may in this case contain both hardware components, for example, in the form of a secure processor and/or a secure memory area, and software components, for example, one or more applications or programs, which interact.

For this purpose, the user terminal requires a digital access key which, however, is not yet available or is no longer available at the time of the start of the method, in particular is not yet available or is no longer available on the present user terminal for the present motor vehicle, because it has not yet been generated, for which the method is carried out, or was previously deleted.

However, at least one valid key for the motor vehicle has already been generated and has been in use by the user, for example, on an additional user terminal designed separately from the present user terminal and which may, in principle, be similar or identical in structure and/or design to the present user terminal.

For the purposes of terminological differentiation, the user terminal on which a digital access key was already previously present can also be referred to as the first user terminal and the user terminal on which a digital access key has not yet been generated and is generated in the course of the method can be referred to as a second user terminal, or vice versa.

In particular, the following exemplary scenario occurred before the method was carried out. The user had a first user terminal designed, for example, as a smartphone and on which a valid digital access key for the motor vehicle was present and stored.

In particular, the valid digital access key was assigned to the user via a user account and linked to both the user, the first user terminal and the motor vehicle, and provided exclusively for this user with this user terminal for this motor vehicle. In particular, the user or the user account is a primary user who is trained and/or has the necessary rights to generate or create an additional digital access key.

Now, the first user terminal is unexpectedly no longer usable, in particular not for the use of the digital access key, for example, because the first user terminal is faulty, has been destroyed, does not work, the battery is empty and/or it has gone missing, such as through loss or theft.

This means that the user may be in the situation that they no longer have access to the or, in particular, their motor vehicle, for example, because the digital access key on the first user terminal was the only valid access key and/or because they are located away from their home, where they might have access to a replacement and/or emergency key, for example, in the form of a physical key.

The user can now gain access to an additional, second user terminal, for example, because they buy a new user terminal or because they borrow a user terminal from a friend, acquaintance or passer-by. This second user terminal is also designed, for example, as a smartphone, but does not yet have a valid access key for the motor vehicle, which is why a replacement digital access key is to be generated by carrying out the method. This replacement access key is not generated, as usual, by using a valid digital access key from a user terminal, in particular the first user terminal, but without using one.

To this end, a generation request by a user to the user terminal, in particular the second user terminal, is first detected in order to generate a replacement digital access key for the motor vehicle.

Since the functions described below predominantly refer to the second user terminal, if there is no terminological distinction between a first and second user terminal, the second user terminal to which the user has access and which did not have a valid digital access key before the method was carried out is meant in the present case. As described above, the user previously had access to a valid digital access key for the motor vehicle, in particular through the first user terminal, and currently no longer has it.

This generation request can be carried out by suitable input means, in particular by a touch screen of the user terminal, in particular a touch input and/or a voice input. The generation request is entered in an application on the user terminal and thereby received on the user terminal, because the user has explicitly selected or actuated one for the generation of a replacement digital access key in the application.

This step of the generation request is an initial or first step of the method or the generation request triggers the method according to the invention. As an alternative, the step of verifying the user described below may be initially for carrying out the method and the step of receiving the generation request may subsequently follow.

The user is thus verified in an additional step of the method using the user terminal. In particular, the user can enter a combination of username and password and/or use a biometric identification function of the user terminal. It is verified whether a or the user of the original valid digital access key is actually the user who legitimately wants to generate a replacement digital access key.

Other examples of such verification as well as other mechanisms for checking the validity or legitimacy of the generation request will be explained in more detail below. In particular, one or more additional devices and/or apparatus that are different, formed separately or at a distance from the user terminal, can be used for verification, as will also be explained in more detail.

If the user has been verified, for example, because they have entered the correct combination of username and password or a biometric identification function has been successful, a replacement digital access key for the motor vehicle is generated on the user terminal, in particular in response to the generation request.

The replacement digital access key is generated using key generation information that does not originate from the first user terminal. This key generation information may have been provided here, as part of the method, to the present, second user terminal, as will be explained in more detail below.

This replacement digital access key may be substantially identical to the original valid digital access key and enable access to the motor vehicle and enable flap control and/or a movement of the motor vehicle.

However, the replacement digital access key may also have a reduced functional range compared to the original digital access key, for example, it may enable flap control but not movement of the motor vehicle, and may have restricted rights, such as no rights to generate an additional digital access key or replacement access key. Further restrictions will be explained in more detail below. The replacement digital access key may then, after generation also be stored in a secure module.

The method according to the invention makes it possible to generate a replacement digital access key for a user after an originally valid digital access key can no longer be used, for example, because a user terminal comprising the originally valid digital access key has a fault or has gone missing and is therefore no longer usable for the use of the original digital access key to access the vehicle.

According to one development, the method additionally comprises the step of receiving key generation information from a remote computing apparatus, wherein the replacement digital access key is created based on the key generation information.

In particular, the key generation information is provided by a remote computing apparatus to the user terminal, more particularly in response to the fact that the user terminal has provided the received generation request to the remote computing apparatus. Together with the generation request, additional information can be provided by the user terminal to the remote computing apparatus, such as user terminal information, which makes it possible to uniquely identify the user terminal. The user terminal information may also include a telephone number and/or an identification, such as an alias, of a messaging service.

The remote computing apparatus, which can also be referred to as a key management apparatus, is formed so as to be different, separate and spaced apart from the motor vehicle and the user terminal. The remote computing apparatus may include one or more servers which are also partially or completely organized in the cloud. The remote computing apparatus can be operated by a manufacturer and/or service provider of the motor vehicle and can be used, in particular exclusively, for the generation and/or management of one or more digital access keys for one or more motor vehicles.

The communication between the user terminal and the remote computing apparatus can be carried out via one or more wireless communication protocols or standards, in particular far-field communication protocols, such as one or more of WLAN or WIFI and/or mobile radio, in particular 3G, 4G, 5G, etc.

The replacement digital access key for the motor vehicle is created based on the key generation information from the remote computing apparatus.

In particular, the replacement digital access key may be based on an asymmetric cryptosystem and/or may use same, wherein both the motor vehicle and the user terminal have a private key and a public key, which are designed to authorize or to legitimize one another.

In particular, the replacement digital access key for use by the user terminal for the motor vehicle and a corresponding key for use by the motor vehicle for the user terminal is created, in particular taking into account user terminal information and motor vehicle information, using the remote computing apparatus which stores and/or receives the user terminal information and/or motor vehicle information, and key generation information is generated based on this.

This development makes it possible to generate the replacement digital access key centrally and with monitoring, thus preventing misuse. This development is particularly secure.

According to one development, the method also comprises the steps of generating verification information based on the verification of the user and generating key generation information at the remote computing apparatus based on the verification information.

Verification information which is created according to the verification process is generated. For example, the verification information may contain information about whether or that the user has been successfully identified, for example, because the user terminal has carried out or performed the verification itself and has provided the result to the remote computing apparatus.

As an alternative or in addition, the verification information may include information collected or entered on the user terminal, such as the combination of username and password of the user, and may be provided to the remote computing apparatus to be verified there. In other words, the user can be verified both on the user terminal, in particular exclusively, and on the remote computing apparatus, in particular exclusively, or also jointly, using the user terminal and the remote computing apparatus as well as using one or more additional devices or apparatus, as will be explained in more detail later.

The key generation information is then generated based on the verification information or depending on the content of the verification information or on the output of the verification. In particular, the key generation information is generated only by the remote computing apparatus and provided to the user terminal if the verification is successful, regardless of whether this is done on the user terminal, the remote computing apparatus and/or both or jointly.

This development makes it possible to generate the replacement digital access key centrally and with monitoring, thus preventing misuse. This development is particularly secure.

According to one development, the user is verified by capturing an image of the user and by capturing an image of a photographic identity card of the user.

Thus, an image of the user is stored on the user terminal for the purpose of verification, in particular an image of the user's face, for example, in a biometric manner, and also an image of an identification document of the user, which includes a photograph of the user.

The image of the photographic identity card may include both the user's image and additional information, such as a first and/or last name, an identification number, a date of issue and/or an expiry date of the identification. The image of the photographic identity card may include a front side of the identification and a rear side of the identification or two different images can be captured. Such photographic identity cards include an official and/or government-issued document, such as a personal identity card, a passport and/or a driver's license.

Both the user's image and the image of the photographic identity card can be taken by one or more cameras of the user terminal. The images can be used as an alternative or in addition to the verification methods described above, such as a combination of username and password or biometric identification function.

The verification can be carried out by comparing the two captured images. For example, an image recognition algorithm can analyze one or more sections of the two images, in particular corresponding sections, such as the eye area and/or the mouth area, and compare them with one another for similarities. An image recognition algorithm can also recognize and read a name, in particular a first and/or last name or name components thereof and compare same with a stored name of the user.

In this case, as previously explained, the verification can also be carried out using the captured images both on the user terminal and on the remote computing apparatus, for example in that the user terminal provides the images and/or information derived therefrom to the remote computing apparatus, or also does this jointly.

This development makes it possible to verify the user particularly easily and quickly, thus preventing misuse. This development is also particularly secure.

According to one development, the verification of the user further comprises providing the image of the user and the image of the photographic identity card to a remote verification apparatus.

According to this development, the captured image of the user and the captured image or images of the photographic identity card and/or at least information obtained therefrom is or are provided to a remote verification apparatus.

The remote verification apparatus may also be included in the previously described remote computing apparatus or the key management apparatus. In other words, the remote computing apparatus can also form the remote verification apparatus or take on the functions thereof.

However, the remote verification apparatus is formed to be different, separate and spaced apart from the remote computing apparatus and also from the motor vehicle and the user terminal. However, the remote verification apparatus may be functionally similar or the same as the remote computing apparatus and comprise one or more servers, which are also partially or completely organized in the cloud.

The remote verification apparatus can be operated by a service provider of verification functions and can be used, in particular exclusively, for the verification of one or more users for a digital access key and, in particular, also other functions requiring verification.

The communication between the user terminal and the remote verification apparatus can also be carried out as described above via one or more wireless communication protocols or standards, in particular far-field communication protocols, such as one or more of WLAN or WIFI and/or mobile radio, in particular 3G, 4G, 5G, etc. Also, communication between the remote verification apparatus and the remote computing apparatus can be set up in the same manner, as will be described in more detail below.

In particular, the remote verification apparatus can partially or completely take over or carry out the verification, in a manner based on the information provided by the user terminal, more particularly exclusively based on this.

The result of the verification can then be returned to the user terminal and/or to the remote computing apparatus. For example, the result of the verification can also be provided exclusively to the user terminal and from there, optionally together with additional information, such as the device information and/or the generation request, can be provided to the remote computing apparatus.

Based on this, key generation information for the replacement digital access key can then be generated at the remote computing apparatus.

This development makes it possible to verify the user particularly centrally and quickly, thus preventing misuse. This development is also particularly secure.

According to one development, the method also comprises the step of authenticating the user at the user terminal, wherein the replacement digital access key is created in response to the authentication.

The user can be authenticated by capturing authentication information on the user terminal. In this case, the step of authenticating the user is different from and formed separately from the previously described step of verifying the user and/or from the step of checking the plausibility of the user described below.

In particular, the steps of authenticating the user, verifying the user and/or checking the plausibility of the user are based on various and different information, records and/or inputs. The process can also be referred to as two-factor authentication, wherein verification is the first factor and the authentication described here is the second factor.

In particular, the authentication of the user may include an input of a PIN, a one-time code and/or the activation of a link.

For example, the user has a PIN, such as a numeric and/or alphanumeric combination, different from the password and/or username.

For example, a one-time code, which can also be referred to as TAN, transaction number, may also have previously been provided by the remote computing apparatus to the user terminal on a second communication channel, for example in response to the provision of the telephone number, in particular by SMS.

Again, for example, a one-time code and/or a link, such as a URL, can be supplied to an e-mail address of the user, which is stored for their user account and which they can access, for example, in a webmail client. The authentication is used, in particular, to ensure that the user is actually in possession of the user terminal and is actually the person they are claiming to be.

The replacement digital access key is then additionally generated in response to and/or based on the authentication. In particular, the replacement digital access key is only generated if the authentication was successful, that is to say the user has been authenticated as such.

In particular, authentication information indicating the authentication is generated on the user terminal and provided to the remote computing apparatus. Furthermore the key generation information is generated based on the authentication information and/or in response thereto at the remote computing apparatus, in particular exclusively, if this information indicates a successful authentication.

In particular, the key generation information is provided to the user terminal in response to the authentication information or based thereon, only if the authentication information indicates a successful authentication.

This development makes it possible to authenticate the user, thus preventing misuse. This development is also particularly secure.

According to one development, the method also comprises the step of checking the plausibility of the user at the user terminal, wherein the replacement digital access key is created in response to the plausibility check.

The plausibility of the user is checked by capturing plausibility information. Plausibility information is in this case information that indicates a plausibility of a legitimacy of the generation request.

For example, an attempt can be made to reach the first user terminal, which comprises the original valid access key, for example by a ping and/or a push notification, and a possible response thereto and, based on this, a plausibility of the generation request can be determined. For example, if the first user terminal sends a response, this may indicate that the user has not lost their first user terminal and/or that this has no restricted function and that the generation request is illegitimate. If, on the other hand, no response is received, it can be concluded from this that the request is plausible and therefore legitimate.

It is also possible to retrieve, for example, when the first user terminal was last online and to determine the plausibility of the generation request based on this. For example, if the first user terminal was online just now or recently, for example less than 5 min, 2 min, 1 min ago or less recently, this may indicate that the user has not lost their first user terminal and/or that this has no restricted function and that the generation request is illegitimate. If, on the other hand, the first user terminal was last online a relatively long time ago, for example, 15 min, 30 min, 60 min or longer ago, it can be concluded from this that the request is plausible and therefore legitimate.

For example, additional information may also be used, in particular a location of the user or the first and/or second user terminal and/or the motor vehicle, in order to assess the plausibility, as will be explained in more detail below.

The replacement digital access key is then additionally generated in response to and/or based on the plausibility check. In particular, the replacement digital access key is only generated if the plausibility check has been successful, that is to say it is plausible that the user or the generation request is legitimate.

In particular, the plausibility information, which indicates the plausibility or the legitimacy of the generation request, is generated or the plausibility thereof is checked at the remote computing apparatus using information from the user terminal and/or the motor vehicle. Furthermore, the key generation information is generated based on the plausibility information and/or in response thereto at the remote computing apparatus, in particular exclusively, if this information indicates a successful plausibility check.

In particular, the key generation information is provided to the user terminal in response to the plausibility information or based thereon, in particular only if the plausibility information indicates a successful authentication.

This development makes it possible to estimate how plausible and therefore how legitimate a generation request is, thus preventing misuse. This development is also particularly secure.

According to one development, the plausibility check of the user includes detection of a location of the user and/or the motor vehicle.

In particular, in order to assess the plausibility of the generation request, a location of the user and of the first user terminal and/or the second user terminal and/or the motor vehicle is detected. For this purpose, the first user terminal, the second user terminal and the motor vehicle may each comprise one or more positioning sensors, such as a GPS sensor.

As an alternative or in addition, a location can also be detected via a radio cell and/or a wireless network in which the first user terminal, the second user terminal and/or the motor vehicle are located or are logged in. The location of the first user terminal may be the most recently recorded location, for example when it was last online.

The plausibility of the user is checked, in particular, by whether the user and, in particular, the first user terminal and/or the second user terminal and/or the motor vehicle are or have been located at a similar or the same location. For example, it is detected whether the first user terminal, the second user terminal and/or the motor vehicle are in the same time zone and/or are less than 100 km, less than 50 km, less than 25 km, less than 10 km, less than 5 km or less apart from one another. For example, if the vehicle and the second user terminal are located in a first location, but the first user terminal is located in a second location more than 50 km from the first location, this may indicate that the generation request is illegitimate. However, if, for example, the first user terminal, the second user terminal and the motor vehicle are or were located less than 10 km apart, then a plausibility and thus a legitimacy of the request can be inferred from this.

This development makes it possible to estimate particularly well and easily how plausible and therefore legitimate a generation request is, thus preventing misuse. This development is also particularly secure.

According to one development, the replacement digital access key has a predetermined validity period.

In particular, the generated replacement digital access key has a limited validity period, for example, of less than 14 days, less than 7 days, less than 3 days, less than 2 days, less than 24 hours, less than 12 hours, less than 6 hours. Once the validity period has expired, the replacement digital access key may lose its validity and/or the functions it allows may be restricted. In particular, the replacement digital access key can be removed or deleted from the user terminal after the expiry of the validity period. After the expiry of the validity period, it may also be necessary to re-authenticate, re-verify and/or re-check the plausibility in order to reactivate the replacement digital access key and/or to lift the functional restrictions again.

The validity period may be predetermined during generation, based on the plausibility check or the plausibility information, the authentication or the authentication information and/or the verification or the verification information. A shorter validity period can be set for a less plausible plausibility check. The validity period may be predetermined or preset by a user and/or by a policy.

This development makes it possible to restrict a validity period of the replacement digital access key, thus preventing misuse. This development is also particularly secure.

An additional aspect specifies a device for restoring access to a motor vehicle using a digital access key.

The device comprises means designed to carry out a method according to any one of the embodiments described above. In particular, the device comprises one or more processor apparatus to carry out the method described above.

In particular, the device also comprises a memory in which code is stored, in a non-volatile manner, which, when executed by a processor apparatus, causes this to carry out the method described above.

In particular, the device may comprise at least one or more user terminals, including the first and/or second user terminal, the motor vehicle, and/or one or more remote computing apparatus, in particular an authentication apparatus and/or a key generation apparatus, may form a system therewith and/or may interact therewith to carry out the method described above.

With regard to the advantages of the device as well as the developments thereof and the advantages thereof, reference is made to the advantages and developments of the method described above.

Further features of the invention emerge from the claims, the figures and the description of the figures. The features and combinations of features mentioned above in the description, and the features and combinations of features mentioned below in the description of the figures and/or shown in the figures alone can be used not only in the respectively specified combination but also in other combinations or on their own.

The invention will now be explained in more detail on the basis of one preferred exemplary embodiment and with reference to the drawing, in which:
Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic perspective view of an embodiment of a method and a device for restoring access to a motor vehicle using a digital access key.

### DETAILED DESCRIPTION OF THE DRAWINGS

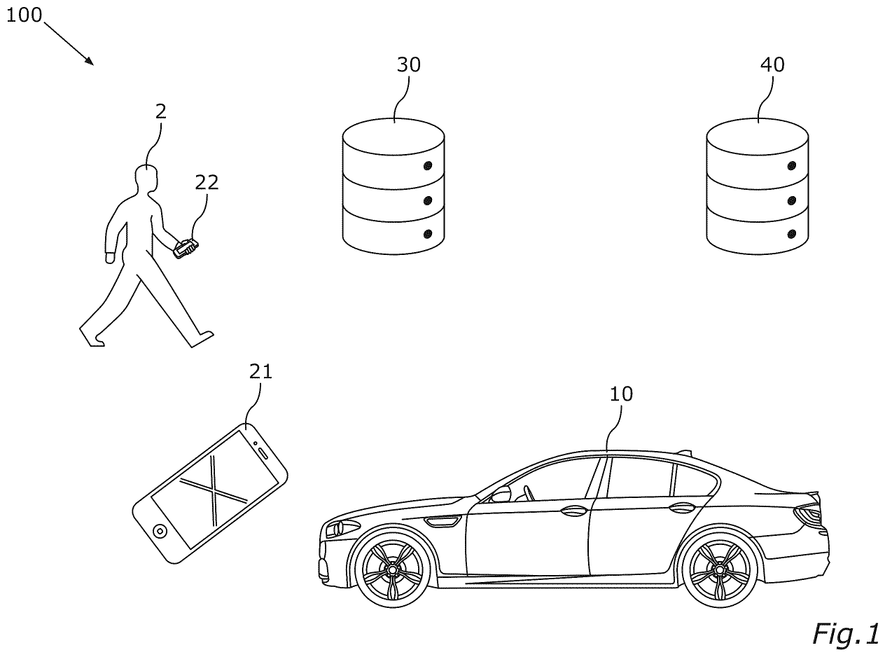

FIG. 1 shows a schematic perspective view of an embodiment of a method and a device 100 for restoring access to a motor vehicle 10 using a digital access key.

The device 100 comprises the motor vehicle 10, a first user terminal 21 and a second user terminal 22 of a user 2, a remote computing apparatus 30 and a remote verification unit 40 and/or has access thereto, to carry out or at least to effect the method steps described below.

The device 100 is initially designed to detect a generation request by the user on the second user terminal 22 in order to generate a replacement digital access key for the motor vehicle 10.

The user 2 previously had access to a valid digital access key for the motor vehicle 10, which was located on the first user terminal 21 but which is no longer functional here, for example, due to a fall.

The device 100 is also designed to verify the user 2 using the user terminal 22.

For this purpose, the device 100 is designed to capture an image of the user 2 and an image of a photographic identity card of the user 2 and to provide same to the remote verification apparatus 40.

The device 100 is also designed to verify the user based on the provided images at the verification apparatus 40.

The device 100 is also designed to generate verification information based on the verification of the user 2 on the verification apparatus and to provide this information to the remote computing apparatus 30.

The device 100 is also designed to authenticate the user 2 on the user terminal.

The device 100 is also designed to generate authentication information based on the authentication of the user 2 on the user terminal 22 and to provide this information to the remote computing apparatus 30.

The device 100 is also designed to check the plausibility of the user 2 at the remote computing device 30.

The device 100 is also designed to generate plausibility information based on the plausibility check of the user 2 at the remote computing apparatus 30. The plausibility is checked here by detecting a location of the first user terminal 21, the second user terminal 22 and the motor vehicle 10.

The device 100 is also designed to generate key generation information based on the verification information, the authentication information and the plausibility information.

The device 100 is also designed to receive the key generation information from the remote computing apparatus 30 on the second user terminal 22.

The device 100 is also designed to generate the replacement digital access key for the motor vehicle 10 on the user terminal 22 based on the received key generation information.

The replacement digital access key has a predetermined, limited validity period.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

2 User
10 Motor vehicle
21 First user terminal
22 Second user terminal
30 Remote computing apparatus
40 Remote verification apparatus
100 Device

What is claimed is:

1. A method for restoring access to a motor vehicle using a digital access key, the method comprising:
detecting a generation request to generate a replacement digital access key for the motor vehicle by a user on a user terminal, wherein the user previously had access to a valid digital access key for the motor vehicle;
verifying the user using the user terminal; and
creating a replacement digital access key for the motor vehicle on the user terminal in response to the verification of the user.

2. The method according to claim 1, further comprising:
receiving key generation information from a remote computing apparatus;
wherein the replacement digital access key is created based on the key generation information.

3. The method according to claim 2, further comprising:
generating verification information based on the verification of the user; and
generating key generation information at the remote computing apparatus based on the verification information.

4. The method according to claim 1, wherein the user is verified by capturing an image of the user and by capturing an image of a photographic identity card of the user.

5. The method according to claim 2, wherein the user is verified by capturing an image of the user and by capturing an image of a photographic identity card of the user.

6. The method according to claim 3, wherein the user is verified by capturing an image of the user and by capturing an image of a photographic identity card of the user.

7. The method according to claim 4, wherein the verification of the user further comprises providing the image of the user and the image of the photographic identity card to a remote verification apparatus.

8. The method according to claim 1, further comprising:
authenticating the user on the user terminal, wherein the replacement digital access key is created in response to authentication.

9. The method according to claim 2, further comprising:
authenticating the user on the user terminal, wherein the replacement digital access key is created in response to authentication.

10. The method according to claim 3, further comprising:
authenticating the user on the user terminal, wherein the replacement digital access key is created in response to authentication.

11. The method according to claim 1, further comprising:
checking a plausibility of the user;
wherein the replacement digital access key is created in response to the plausibility check.

12. The method according to claim 2, further comprising:
checking a plausibility of the user;
wherein the replacement digital access key is created in response to the plausibility check.

13. The method according to claim 3, further comprising:
checking a plausibility of the user;
wherein the replacement digital access key is created in response to the plausibility check.

14. The method according to claim 11, wherein the plausibility check of the user includes detection of a location of the user or the motor vehicle.

15. The method according to claim 1, wherein the replacement digital access key has a predetermined validity period.

16. The method according to claim 2, wherein the replacement digital access key has a predetermined validity period.

17. The method according to claim 3, wherein the replacement digital access key has a predetermined validity period.

18. An apparatus for restoring access to a motor vehicle using a digital access key, the apparatus comprising:
a hardware processor; and
a memory coupled to the hardware processor and storing a program configured to cause the hardware processor to execute a method for restoring access to a motor vehicle using a digital access key, the method including:
detecting a generation request to generate a replacement digital access key for the motor vehicle by a user on a user terminal, wherein the user previously had access to a valid digital access key for the motor vehicle;
verifying the user using the user terminal; and
creating a replacement digital access key for the motor vehicle on the user terminal in response to the verification of the user.
